(19) United States
(12) Patent Application Publication
(10) Pub. No.: US 2023/0194706 A1
(43) Pub. Date: Jun. 22, 2023

(54) ATMOSPHERIC SENSING USING WIGIG-MMWAVE TECHNOLOGIES

(71) Applicants: Sagar Gupta, Ghaziabad (IN); Jay Vishnu Gupta, Bengaluru (IN); Maruti Tamrakar, Chennai (IN); Jayprakash Thakur, Babgalore (IN); Prathibha Peddireddy, Bengaluru (IN)

(72) Inventors: Sagar Gupta, Ghaziabad (IN); Jay Vishnu Gupta, Bengaluru (IN); Maruti Tamrakar, Chennai (IN); Jayprakash Thakur, Babgalore (IN); Prathibha Peddireddy, Bengaluru (IN)

(21) Appl. No.: 17/559,492

(22) Filed: Dec. 22, 2021

(51) Int. Cl. G01S 13/95; G01S 7/497; G01S 7/48; H04B 17/391; H04L 5/00

(52) U.S. Cl. CPC G01S 13/95; G01S 7/497; G01S 7/4802; H04B 17/391; H04L 5/0048

(57) ABSTRACT

An apparatus for a wireless device includes a signal generation circuit configured to generate a reference signal and modify the reference signal to obtain an adjusted reference signal. The apparatus further includes a signal processing circuit configured to cause transmission of the adjusted reference signal via one or more antennas. A reflected signal received by the one or more antennas is detected. The reflected signal corresponds to the adjusted reference signal. A comparison of the reflected signal is performed with a feedback signal. The feedback signal is generated based on the reference signal. An atmospheric attenuation level for the location of the wireless device is determined based on the comparison. A notification is generated based on the atmospheric attenuation level.

### TECHNICAL FIELD

Embodiments pertain to improvements in computer architectures, including improvements in environmental conditions sensing, including techniques for atmospheric sensing using WiGig and Fifth Generation (5G) millimeter wave (mmW) technologies.

### BACKGROUND

Mobile communications have evolved significantly from early voice systems to today's highly sophisticated integrated communication platform. With the increase in different types of devices communicating with various network devices, usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next generation 5G networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in the unlicensed spectrum without requiring an “anchor” in the licensed spectrum, called MulteFire. Further enhanced operation of LTE and NR systems in the licensed, as well as unlicensed spectrum, is expected in future releases as well as WiGig and mmW systems. Such enhanced operations can include techniques for supporting real-time sensing of environmental conditions, including detecting atmospheric conditions in a vicinity of a wireless device, using WiGig and mmW technologies.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings in which:

FIG. 1 is a block diagram of a radio architecture including an interface card with an atmospheric detection circuit for detecting atmospheric conditions, in accordance with some embodiments:

FIG. 2 illustrates a front-end module circuitry for use in the radio architecture of FIG. 1, in accordance with some embodiments;

FIG. 3 illustrates a radio IC circuitry for use in the radio architecture of FIG. 1, in accordance with some embodiments;

FIG. 4 illustrates a baseband processing circuitry for use in the radio architecture of FIG. 1, in accordance with some embodiments;

FIG. 5 is a graph illustrating atmospheric attenuation based on a frequency which can be used in accordance with some embodiments;

FIG. 6 illustrates a block diagram of an atmospheric detection circuit for determining atmospheric conditions, in accordance with some embodiments;

FIG. 7 illustrates a flow diagram of a method for determining atmospheric conditions in a vicinity of a wireless device, in accordance with some embodiments; and

FIG. 8 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

WiGig is an upcoming Wi-Fi standard for Internet connectivity and data transfer. Additionally, for high-speed data communication, 5G mmW technology is going to be a part of upcoming wireless devices. The operating frequency of the WiGig standard is 60 GHz (the alternate name of WiGig is 60 GHz Wi-Fi). This upcoming technology will allow very high speed (in the range of GBs) data transmission without any wired network.

Similarly, the operating frequencies (e.g., frequency range 2 or FR2) of 5G antennas can be configured in an mmW range (24.25 GHz to 52.6 GHz). These antennas are directional and can be used in the form of arrays to obtain coverage in different directions. Also, such antennas provide a range of up to 10 meters which gives accurate sensing data only for the nearby atmosphere.

Wireless computing devices (e.g., personal computers, laptops, tablets, smartphones, etc.) can be configured with WiGig (or 60 GHz Wi-Fi) and mmW antennas used for Internet connectivity and data transfer. In some embodiments, such WiGig/mmW antennas can be used (e.g., by the disclosed atmospheric detection circuit) for real-time sensing of the surrounding atmosphere and detecting atmospheric conditions. For example, WiGig/mmW antennas can be used for sensing air index, O2 levels, carbon levels, humidity levels, or other environmental conditions in the vicinity of the antennas and the computing device. A notification can be generated based on the detected atmospheric conditions or another corrective measure can be implemented (e.g., automatic adjustment of a device regulating environmental conditions such as a humidifier, air purifier, dehumidifier, etc.).

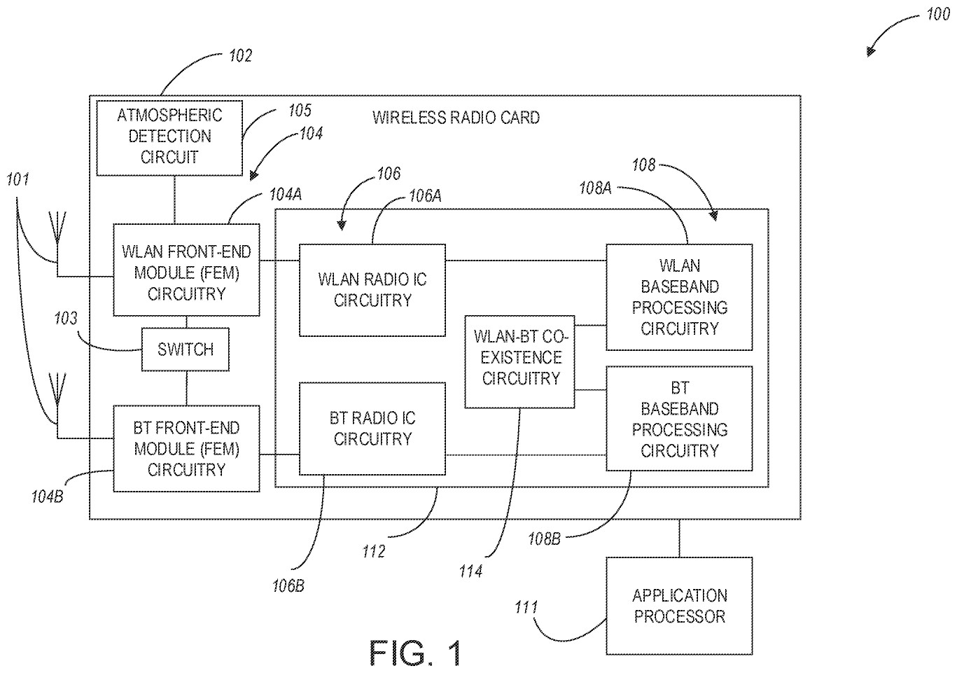

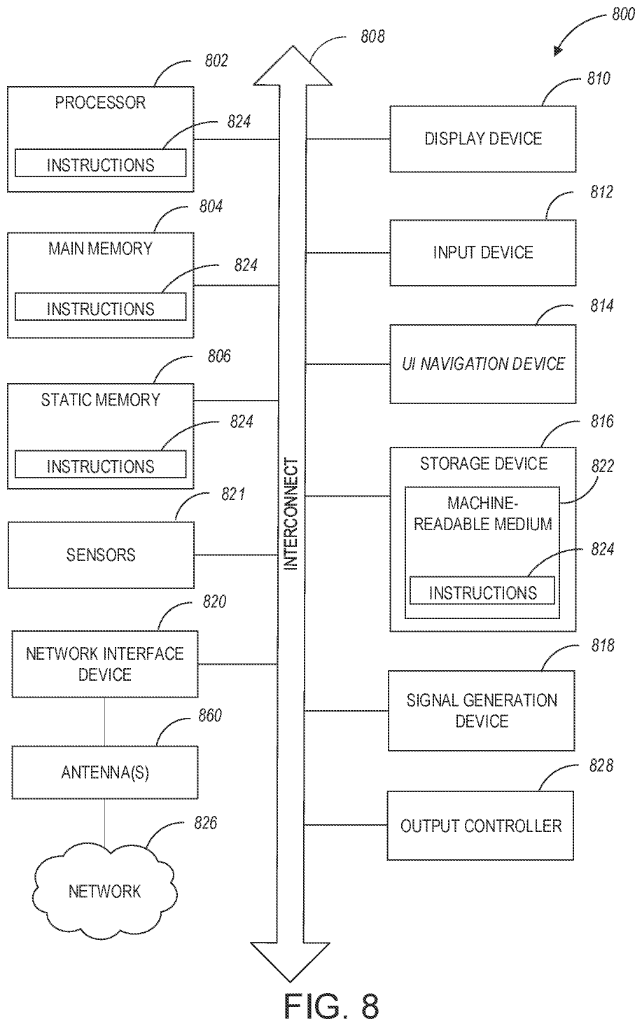

FIG. 1 is a block diagram of a radio architecture 100 including an interface card 102 with an atmospheric detection circuit 105 for detecting atmospheric conditions, in accordance with some embodiments. The radio architecture 100 may be implemented in a computing device (e.g., device 800 in FIG. 8) including user equipment (UE), a base station (e.g., a next generation Node-B (gNB), enhanced Node-B (eNB)), a smartphone, a personal computer (PC), a laptop, a tablet, or another type of wired or wireless device. The radio architecture 100 may include radio front-end module (FEM) circuitry 104, radio integrated circuit (IC) circuitry 106, and baseband processing circuitry 108 configured as part of the interface card 102. In this regard, radio architecture 100 (as shown in FIG. 1) includes an interface card 102 configured to perform both Wireless Local Area Network (WLAN) functionalities and Bluetooth (BT) functionalities (e.g., as WLAN/BT interface or modem card), although embodiments are not so limited and the disclosed techniques apply to other types of radio architectures with different types of interface cards as well. In this disclosure, “WLAN” and “Wi-Fi” are used interchangeably. Other example types of interface cards which can be used in connection with the disclosed techniques include graphics cards, network cards, SSD cards (such as M.2-based cards), CEM-based cards, etc.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals, and to provide the amplified versions of the received signals to the WLAN radio IC circuitry 106A for further processing. The BT FEM circuitry 104B may include a receive signal path which may include circuitry configured to operate on BT RF signals received from the one or more antennas 101, to amplify the received signals and to provide the amplified versions of the received signals to the BT radio IC circuitry 106B for further processing. The WLAN FEM circuitry 104A may also include a transmit signal path which may include circuitry configured to amplify WLAN signals provided by the radio IC circuitry 106A for wireless transmission by the one or more antennas 101. Besides, the BT FEM circuitry 104B may also include a transmit signal path which may include circuitry configured to amplify BT signals provided by the radio IC circuitry 106B for wireless transmission by the one or more antennas. In the embodiment of FIG. 1, although WLAN FEM circuitry 104A and BT FEM circuitry 104B are shown as being distinct from one another, embodiments are not so limited and include within their scope the use of a FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the WLAN FEM circuitry 104A and provide baseband signals to WLAN baseband processing circuitry 108A. The BT radio IC circuitry 106B may, in turn, include a receive signal path which may include circuitry to down-convert BT RF signals received from the BT FEM circuitry 104B and provide baseband signals to BT baseband processing circuitry 108B. The WLAN radio IC circuitry 106A may also include a transmit signal path which may include circuitry to up-convert WLAN baseband signals provided by the WLAN baseband processing circuitry 108A and provide WLAN RF output signals to the WLAN FEM circuitry 104A for subsequent wireless transmission by the one or more antennas 101. The BT radio IC circuitry 106B may also include a transmit signal path which may include circuitry to up-convert BT baseband signals provided by the BT baseband processing circuitry 108B and provide BT RF output signals to the BT FEM circuitry 104B for subsequent wireless transmission by the one or more antennas 101. In the embodiment of FIG. 1, although radio IC circuitries 106A and 106B are shown as being distinct from one another, embodiments are not so limited and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform (FFT) or Inverse Fast Fourier Transform (IFFT) block (not shown) of the WLAN baseband processing circuitry 108A. Each of the WLAN baseband processing circuitry 108A and the BT baseband processing circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include a physical layer (PHY) and medium access control layer (MAC) circuitry and may further interface with a host processor (e.g., the application processor 111) in a host system (e.g., a host SoC) for generation and processing of the baseband signals and for controlling operations of the radio IC circuitry 106 (including controlling the operation of the atmospheric detection circuit 105).

Referring still to FIG. 1, according to the shown embodiment, WLAN-BT coexistence circuitry 114 may include logic providing an interface between the WLAN baseband processing circuitry 108A and the BT baseband processing circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the one or more antennas 101 are depicted as being respectively connected to the WLAN FEM circuitry 104A and the BT FEM circuitry 104B, embodiments include within their scope the sharing of the one or more antennas 101 as between the WLAN and BT FEMs, or the provision of more than one antenna connected to each of FEM circuitries 104A or 104B.

In some embodiments, the front-end module circuitry 104, the radio IC circuitry 106, and the baseband processing circuitry 108 may be provided on a single radio card, such as the interface card 102. In some other embodiments, the one or more antennas 101, the FEM circuitry 104, and the radio IC circuitry 106 may be provided on a single radio card. In some other embodiments, the radio IC circuitry 106 and the baseband processing circuitry 108 may be provided on a single chip or IC, such as IC 112.

In some embodiments, the interface card 102 can be configured as a wireless radio card, such as a WLAN radio card configured for wireless communications (e.g., WiGig communications in the 60 GHz range or mmW communications in 24.24 GHz-52.6 GHz range), although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

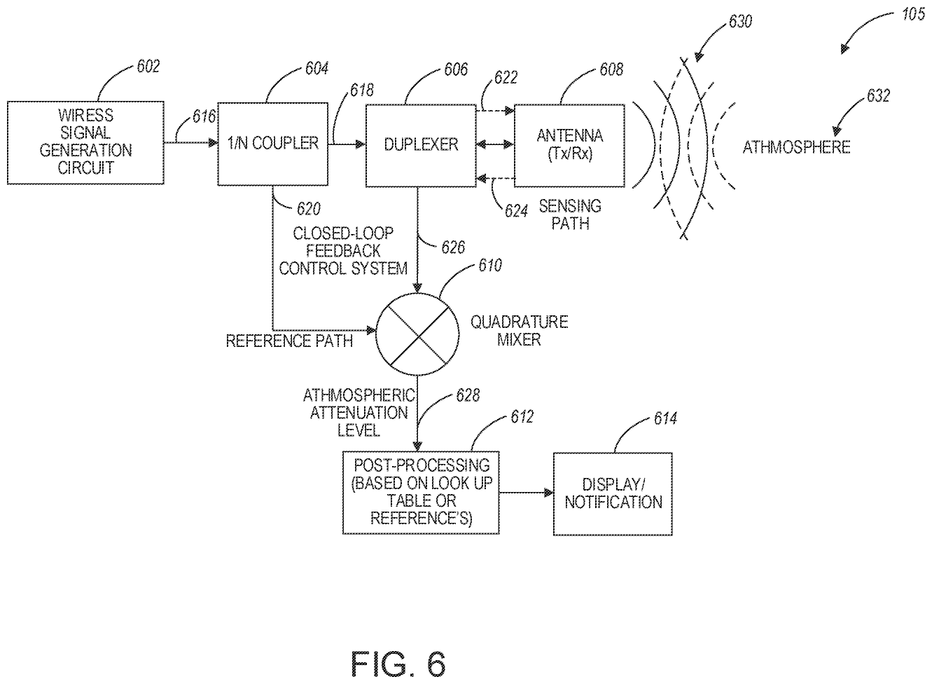

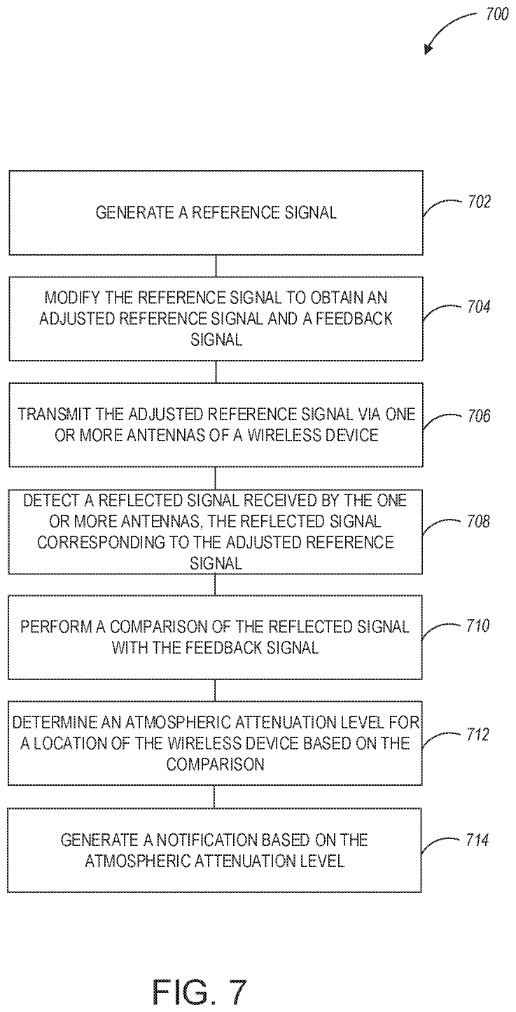

In some embodiments, the interface card 102 may include an atmospheric detection circuit 105 configured to perform disclosed functionalities in connection with determining atmospheric conditions in a vicinity of a wireless device. In some aspects, the atmospheric detection circuit 105 can use one or more other circuits of the interface card 102 as well as processing functionalities of one or more processors, such as application processor 111. A more detailed description of the atmospheric detection circuit 105 is provided in connection with, e.g., FIGS. 6-7.

In some of these multicarrier embodiments, radio architecture 100 may be part of a Wi-Fi communication station (STA) such as a wireless access point (AP), a base station, or a mobile device including a Wi-Fi enabled device. In some of these embodiments, radio architecture 100 may be configured to transmit and receive signals in accordance with specific communication standards and/or protocols, such as any of the Institute of Electrical and Electronics Engineers (IEEE) standards including, 802.11n-2009, IEEE 802.11-2012, 802.11n-2009, 802.1 lac, IEEE 802.11-2016, 802.11ad, and/or 802.1 lax standards and/or proposed specifications for WLANs, although the scope of embodiments is not limited in this respect and operations using other wireless standards can also be configured. Radio architecture 100 may also be suitable to transmit and/or receive communications in accordance with other techniques and standards, including a 3^{rd} Generation Partnership Project (3GPP) standard, including a communication standard used in connection with 5G or new radio (NR) communications.

In some embodiments, the radio architecture 100 may be configured for high-efficiency (HE) Wi-Fi communications in accordance with the IEEE 802.11ax standard or another standard associated with wireless communications. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband processing circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection-oriented (SCO) link and or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as the interface card 102, although embodiments are not so limited, and include within their scope discrete WLAN and BT radio cards

In some embodiments, the radio architecture 100 may include other radio cards, such as a cellular radio card configured for cellular/wireless communications (e.g., 3GPP such as LTE, LTE-Advanced, WiGig, or 5G communications including mmW communications), which may be implemented together with (or as part of) the interface card 102.

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies, however.

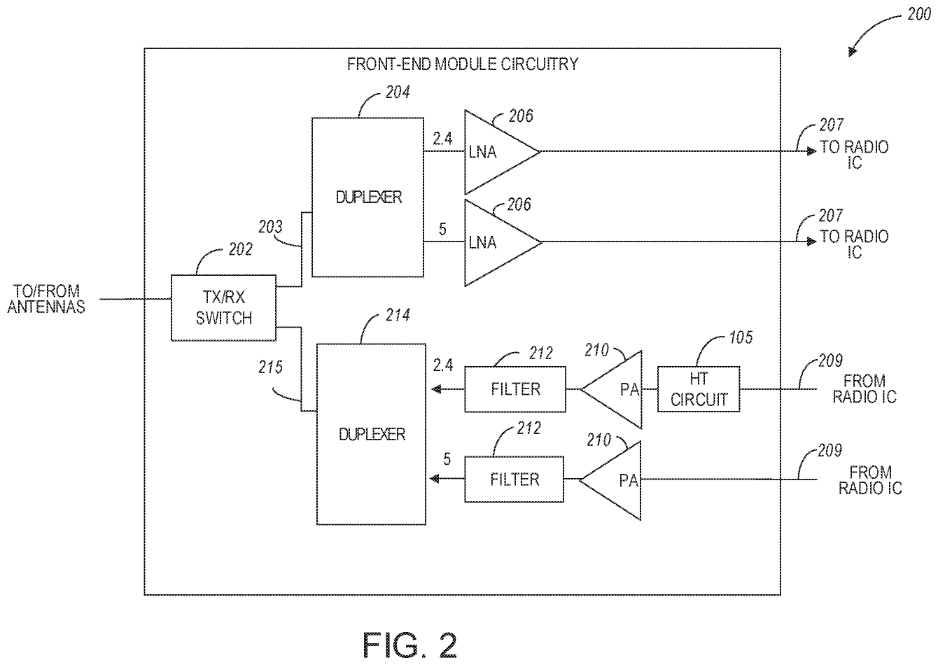

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit (TX) mode and receive (RX) mode operation. In some aspects, a diplexer may be used in place of a TX/RX switch. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the FEM circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by the one or more antennas 101 (FIG. 1)).

In some dual-mode embodiments for Wi-Fi communication, the FEM circuitry 200 may be configured to operate in, e.g., either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier (PA) 210 and one or more filters 212, such as a BPF, an LPF, or another type of filter for each frequency spectrum, and a transmit signal path duplexer 214 to provide the signals of one of the different spectrums onto a single transmit path for subsequent transmission by the one or more antennas 101 (FIG. 1). In some embodiments, BT communications may utilize the 2.4 GHz signal paths and may utilize the same FEM circuitry 200 as the one used for WLAN communications.

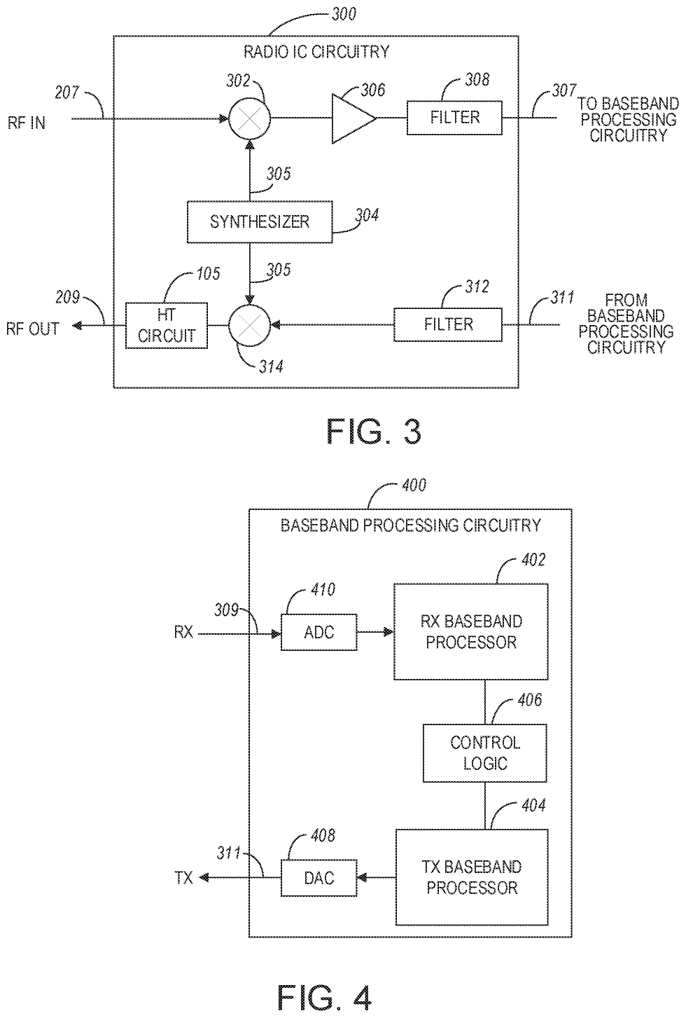

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include mixer circuitry 302, such as, for example, down-conversion mixer circuitry, amplifier circuitry 306, and filter circuitry 308. The transmit signal path of the radio IC circuitry 300 may include at least filter circuitry 312 and mixer circuitry 314, such as up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry and may include, although not shown, embodiments where each of the depicted circuitries may include more than one component. For instance, mixer circuitry 302 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by the synthesizer circuitry 304. The amplifier circuitry 306 may be configured to amplify the down-converted signals and the filter circuitry 308 may include an LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate the input RF signals 209 for the FEM circuitry 104. The baseband signals 311 may be provided by the baseband processing circuitry 108 and may be filtered by filter circuitry 312. The filter circuitry 312 may include an LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of the synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature-phase (Q) paths). In such an embodiment, RF input signal 207 from FIG. 2 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as synthesized frequency (or LO frequency) 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in the duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature-phase (Q) path) may operate at a 25% duty cycle, which may result in a significant reduction in power consumption.

The RF input signal 207 (FIG. 2) may comprise a balanced signal, although the scope of the embodiments is not limited in this respect. The I and Q baseband output signals may be provided to the low-noise amplifier, such as amplifier circuitry 306 (FIG. 3) or to filter circuitry 308 (FIG. 3).

In some embodiments, the output baseband signals 307 and the input baseband signals 311 may be analog, although the scope of the embodiments is not limited in this respect. In some alternate embodiments, the output baseband signals 307 and the input baseband signals 311 may be digital. In these alternate embodiments, the radio IC circuitry may include an analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. In some embodiments, the synthesizer circuitry 304 may be a delta-sigma synthesizer, a frequency multiplier, or a synthesizer comprising a phase-locked loop with a frequency divider. According to some embodiments, the synthesizer circuitry 304 may include a digital frequency synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage-controlled oscillator (VCO), although that is not a requirement. A divider control input may further be provided by either the baseband processing circuitry 108 (FIG. 1) or the application processor 111 (FIG. 1) depending on the desired frequency output as synthesized frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the synthesized frequency 305, while in other embodiments, the synthesized frequency 305 may be a fraction of the carrier frequency (e.g., one-half the carrier frequency, one-third the carrier frequency). In some embodiments, the synthesized frequency 305 may be a LO frequency (fLO).

FIG. 4 illustrates a baseband processing circuitry 400 for use in the radio architecture of FIG. 1, in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include an analog-to-digital converter (ADC) 410 to convert analog baseband signals 309 received from the radio IC circuitry 106 to digital baseband signals for processing by the RX BBP 402. In these embodiments, the baseband processing circuitry 400 may also include a digital-to-analog converter (DAC) 408 to convert digital baseband signals from the TX BBP 404 to analog baseband signals 311.

In some embodiments that communicate OFDM signals or OFDMA signals, such as through the WLAN baseband processing circuitry 108A, the TX BBP 404 may be configured to generate OFDM or OFDMA signals as appropriate for transmission by performing an inverse fast Fourier transform (IFFT). The RX BBP 402 may be configured to process received OFDM signals or OFDMA signals by performing an FFT. In some embodiments, the RX BBP 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the one or more antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. The one or more antennas 101 may each include a set of phased-array antennas, although embodiments are not so limited.

Although the radio architecture 100 is illustrated as having several separate functional elements, one or more of the functional elements may be combined and may be implemented by combinations of software configured elements, such as processing elements including digital signal processors (DSPs), and/or other hardware elements. For example, some elements may comprise one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

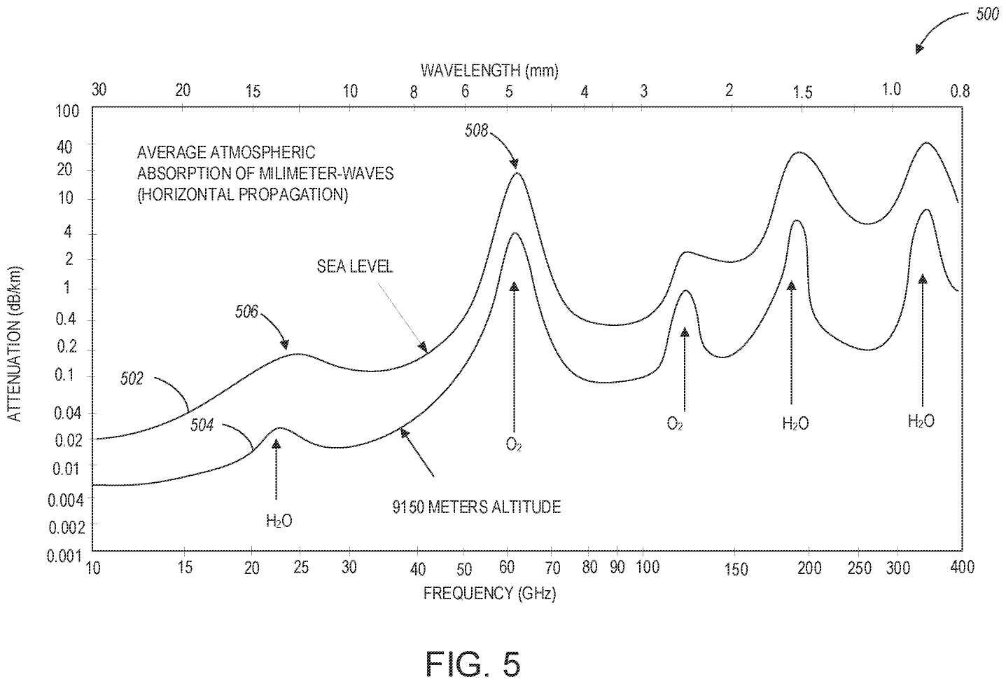

In some embodiments, WiGig/mmW antennas can be used for real-time sensing and determining of environmental conditions including the air index, oxygen level, water vapor (humidity) level, and other environmental conditions of the surrounding atmosphere in the vicinity of the antennas. More specifically, WiGig and 5G mmW antennas are sharp beam array antennas that can be used as mono-static radar for sensing applications. The atmosphere particles and gases are prone to certain frequency bands (e.g., WiGig and mmW bands as illustrated in FIG. 5) and absorb the signal for the particular frequency. This feature of signal absorption can be used for sensing purposes and the determination of environmental conditions. In some aspects, sensing data collected from signal attenuation at a particular frequency can be used as an indicator for environmental conditions.

The disclosed environmental conditions sensing applications can be configured using built-in antennas, without any additional antenna requirements, and can be used to detect such environmental conditions in real-time with optional notification and other device control functions (e.g., automatically activate or deactivate air conditioning, air purification, humidification, dehumidification, etc.).

FIG. 5 is a graph 500 illustrating atmospheric attenuation based on a frequency that can be used in accordance with some embodiments. More specifically, graph 500 in FIG. 5 illustrates example atmospheric absorption curves 502 (for sea level) and 504 (for an altitude of 9150 meters). Additionally, FIG. 5 illustrates water vapor (H2O) and oxygen (O2) absorption resulting in signal attenuation at particular absorption frequencies. For example, the water vapor attenuation line is passing near the 24 GHz band and the first oxygen attenuation line is near 60 GHz. Such frequencies are also the operating frequencies of the WiGig/5G mmW wireless applications and can be used (e.g., by the disclosed atmospheric detection circuit) in connection with determining atmospheric conditions in a vicinity of a wireless device. For example, the WiGig/mmW operating frequencies are used to obtain the absorption level of the radiated fields from the antenna. To obtain the precise attenuation value of water/oxygen in the atmosphere, the atmospheric detection circuit with a closed-loop feedback control system can be used as shown in FIG. 6.

FIG. 6 illustrates a block diagram of the atmospheric detection circuit 105 for determining atmospheric conditions, in accordance with some embodiments. Referring to FIG. 6, the atmospheric detection circuit 105 includes a wireless signal generation circuit 602, a coupler 604, a duplexer 606, one or more antennas 608, a quadrature mixer 610, a post-processing circuit 612, and a notification circuit 614. The wireless signal generation circuit 602 can include signal generation circuitry of the interface card 102 including any of the radio FEM circuitry 104, radio IC circuitry 106, and the baseband processing circuitry 108. The one or more antennas 608 can be the same as antennas 101.

The coupler 604 can be a directional coupler, such as a 3 dB directional coupler configured to split the power level of a reference signal 616 to generate an adjusted reference signal 618 and a feedback signal 620. In some aspects, coupler 604 can be a 1/n coupler. The feedback signal 620 can be communicated via the reference path to quadrature mixer 610.

Duplexer 606 is configured to communicate the adjusted reference signal 618 via transmission path 622 to the one or more antennas 608 for transmission. A reflected signal 630 is generated based on reflection of the transmitted adjusted reference signal 618 via the surrounding atmosphere 632. The reflected signal 630 is received by the one or more antennas 608 and is communicated to the duplexer 606 via the sensing path 624, where it is communicated to the quadrature mixer 610 via communication path 626.

Quadrature mixer 610 mixes the reflected signal 630 with the feedback signal 620 to generate a mixed signal 628. A comparison of the reflected signal with the feedback signal can be generated based on the mixed signal. In some embodiments, the mixed signal 628 is indicative of atmospheric attenuation level for a location of the wireless device in proximity of the surrounding atmosphere 632. The post-processing circuit 612 is configured to determine atmospheric condition characteristics associated with the location of the wireless device using a lookup table (LUT) or other pre-configured reference data based on the mixed signal (e.g., based on the atmospheric attenuation level associated with the mixed signal or determined based on the mixed signal). In some embodiments, the LUT can be based on local atmospheric conditions of a particular geo-location (e.g., the geo-location of the atmospheric detection circuit 105). In this regard, the LUT can be configured/obtained using a separate cloud-based or another type of weather-related application providing weather-related data for a particular location. The atmospheric condition characteristics can include an oxygen level, air index, humidity level, carbon level, or other atmospheric condition characteristics.

The notification circuit 614 can include a display to provide a visual notification of the determined atmospheric condition characteristic or can perform another notification or configuration functionality (e.g., automatically initiate air purification, air conditioning, dehumidification, humidification, or another functionality to adjust the atmospheric condition characteristics).

In some embodiments, an apparatus for a wireless device (e.g., device 800 implementing radio architecture 100) includes a signal generation circuit (e.g., atmospheric detection circuit 105) configured to generate a reference signal (e.g., reference signal 616 generated via the wireless signal generation circuit 602). The signal generation circuit is further to modify the reference signal to obtain an adjusted reference signal and a feedback signal. For example, the directional coupler 604 power-splits the reference signal 616 to generate the adjusted reference signal 618 and the feedback signal 620. The signal processing circuit is further to cause transmission of the adjusted reference signal 618 via one or more antennas (e.g., one or more antennas 608 receive the adjusted reference signal 618 via the duplexer 606). A signal processing circuit (e.g., the application processor 111 or another processing circuit of the atmospheric detection circuit 105) is further to detect a reflected signal 630 received by the one or more antennas 608. The reflected signal 630 corresponds to the adjusted reference signal 618 (e.g., the reflected signal is generated as a reflection of the transmitted adjusted reference signal by the surrounding atmosphere 632). The signal processing circuit can perform a comparison of the reflected signal 630 with the feedback signal 620. For example, the quadrature mixer 610 can generate a mixed signal 628 based on the reflected signal 630 with the feedback signal 620. The mixed signal 628 can be used as a measure of the comparison. The signal processing circuit can be configured to determine an atmospheric attenuation level for a location of the wireless device (e.g., based on the comparison), and generate a notification based on the atmospheric attenuation level.

In some aspects, the signal generation circuit includes a directional coupler 604 configured to reduce the power level of the reference signal 616 to generate the adjusted reference signal 618 and the feedback signal 620. In some aspects, the directional coupler is a 3 dB directional coupler. In some aspects, the signal power of the adjusted reference signal is equal to the signal power of the feedback signal as adjusted by the 3 dB directional coupler.

In some aspects, the signal generation circuit includes a duplexer (e.g., duplexer 606). The duplexer is configured to output the adjusted reference signal to the one or more antennas 608 via a first communication path (e.g., transmission path 622), and receive the reflected signal 630 from the one or more antennas via a second communication path (e.g., sensing path 624).

In some aspects, the signal generation circuit includes a quadrature mixer 610 configured to generate a mixed signal 628 using the reflected signal and the feedback signal. In some embodiments, the signal processing circuit is configured to perform the comparison of the reflected signal with the feedback signal based on the mixed signal. In some embodiments, the signal processing circuit is configured to determine an atmospheric condition characteristic associated with the location of the wireless device based on the atmospheric attenuation level, and generate the notification to include the atmospheric condition characteristic. To determine the atmospheric condition characteristic, the signal processing circuit is configured to perform post-processing (e.g., via the post-processing circuit 612) using a LUT and the atmospheric attenuation level. In some aspects, the atmospheric condition characteristic includes oxygen level, carbon level, humidity level, and/or air index level. The air index level is indicative of air pollution at the location of the wireless device.

FIG. 7 illustrates a flow diagram of a method 700 for detecting atmospheric conditions in a vicinity of a wireless device, in accordance with some embodiments. Referring to FIG. 7, method 700 includes operations 702, 704, 706, 708, 710, 712, and 714, which may be executed by the atmospheric detection circuit 105 or another processor of a computing device (e.g., hardware processor 802 of device 800 illustrated in FIG. 8).

At operation 702, a reference signal is generated. For example, an apparatus for a wireless device (e.g., device 800 implementing radio architecture 100) includes a signal generation circuit (e.g., atmospheric detection circuit 105) configured to generate a reference signal (e.g., reference signal 616 generated via the wireless signal generation circuit 602).

At operation 704, the reference signal is modified to obtain an adjusted reference signal and a feedback signal. For example, the directional coupler 604 power-splits the reference signal 616 to generate the adjusted reference signal 618 and the feedback signal 620.

At operation 706, the adjusted reference signal is transmitted via one or more antennas of the wireless device. For example, the signal processing circuit is further to cause transmission of the adjusted reference signal 618 via one or more antennas (e.g., one or more antennas 608 receive the adjusted reference signal 618 via the duplexer 606).

At operation 708, a reflected signal received by the one or more antennas is detected, where the reflected signal corresponds to the adjusted reference signal. For example, a signal processing circuit (e.g., the application processor 111 or another processing circuit of the atmospheric detection circuit 105) is further to detect a reflected signal 630 received by the one or more antennas 608. The reflected signal 630 corresponds to the adjusted reference signal 618 (e.g., the reflected signal is generated as a reflection of the transmitted adjusted reference signal by the surrounding atmosphere 632).

At operation 710, a comparison of the reflected signal with a feedback signal is performed, where the feedback signal is generated based on the reference signal. For example, the signal processing circuit can perform a comparison of the reflected signal 630 with the feedback signal 620. For example, the quadrature mixer 610 can generate a mixed signal 628 based on the reflected signal 630 with the feedback signal 620. The mixed signal 628 can be used as a measure of the comparison.

At operation 712, an atmospheric attenuation level for the location of the wireless device is determined based on the comparison. At operation 714, a notification is generated (e.g., by the notification circuit 614) based on the atmospheric attenuation level.

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, machine 800 may operate in the capacity of a server machine, a client machine, or both in server-client network environments. In an example, the machine 800 may act as a peer machine in a peer-to-peer (P2P) (or other distributed) network environment. The machine 800 may be a personal computer (PC), a tablet PC, a set-top box (STB), a personal digital assistant (PDA), a portable communications device, a mobile telephone, a smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 800 may include a hardware processor 802 (e.g., a central processing unit (CPU), a graphics processing unit (GPU), a hardware processor core, or any combination thereof), a main memory 804, and a static memory 806, some or all of which may communicate with each other via an interlink (e.g., bus) 808.

Specific examples of main memory 804 include Random Access Memory (RAM), and semiconductor memory devices, which may include, in some embodiments, storage locations in semiconductors such as registers. Specific examples of static memory 806 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 800 may further include a display device 810, an input device 812 (e.g., a keyboard), and a user interface (UI) navigation device 814 (e.g., a mouse). In an example, the display device 810, input device 812, and UI navigation device 814 may be a touch screen display. The machine 800 may additionally include a storage device (e.g., drive unit or another mass storage device) 816, a signal generation device 818 (e.g., a speaker), a network interface device 820, and one or more sensors 821, such as a global positioning system (GPS) sensor, compass, accelerometer, or other sensors. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the processor 802 and/or instructions 824 may comprise processing circuitry and/or transceiver circuitry.

The storage device 816 may include a machine-readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 822 is illustrated as a single medium, the term “machine-readable medium” may include a single medium or multiple media (e.g., a centralized or distributed database, and/or associated caches and servers) configured to store one or more instructions 824.

An apparatus of the machine 800 may be one or more of a hardware processor 802 (e.g., a central processing unit (CPU), a graphics processing unit (GPU), a hardware processor core, or any combination thereof), a main memory 804 and a static memory 806, one or more sensors 821, a network interface device 820, antennas 860, a display device 810, an input device 812, a UI navigation device 814, a storage device 816, instructions 824, a signal generation device 818, and an output controller 828. The apparatus may be configured to perform one or more of the methods and/or operations disclosed herein. The apparatus may be intended as a component of the machine 800 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks, magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 820 may include one or more physical jacks (e.g., Ethernet, coaxial, or phone jacks) or one or more antennas to connect to the communications network 826. In an example, the network interface device 820 may include one or more antennas 860 to wirelessly communicate using at least one single-input multiple-output (SIMO), multiple-input multiple-output (MIMO), or multiple-input single-output (MISO) techniques. In some examples, the network interface device 820 may wirelessly communicate using Multiple User MIMO techniques. The term “transmission medium” shall be taken to include any intangible medium that is capable of storing, encoding, or carrying instructions for execution by the machine 800, and includes digital or analog communications signals or other intangible media to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media, optical storage media; flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in a number of environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the disclosure is not limited in this respect.

Antennas referred to herein may comprise one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each of antennas and the antennas of a transmitting station. In some MIMO embodiments, antennas may be separated by up to 1/10 of a wavelength or more.

Described implementations of the subject matter can include one or more features, alone or in combination as illustrated below by way of examples.

Example 1 is an apparatus for a wireless device, the apparatus comprising: a signal generation circuit configured to generate a reference signal, and modify the reference signal to obtain an adjusted reference signal; and a signal processing circuit configured to cause transmission of the adjusted reference signal via one or more antennas; detect a reflected signal received by the one or more antennas, the reflected signal corresponding to the adjusted reference signal; perform a comparison of the reflected signal with a feedback signal, the feedback signal generated based on the reference signal; determine an atmospheric attenuation level for a location of the wireless device based on the comparison; and generate a notification based on the atmospheric attenuation level.

In Example 2, the subject matter of Example 1 includes, wherein the signal generation circuit comprises a directional coupler, the directional coupler configured to reduce a power level of the reference signal to generate the adjusted reference signal and the feedback signal.

In Example 3, the subject matter of Example 2 includes, wherein the directional coupler is a 3 dB directional coupler, and wherein the signal power of the adjusted reference signal is equal to the signal power of the feedback signal.

In Example 4, the subject matter of Examples 2-3 includes, a duplexer, the duplexer configured to output the adjusted reference signal to the one or more antennas via a first communication path; and receive the reflected signal from the one or more antennas via a second communication path.

In Example 5, the subject matter of Example 4 includes, a quadrature mixer configured to generate a mixed signal using the reflected signal and the feedback signal.

In Example 6, the subject matter of Example 5 includes, wherein the signal processing circuit is configured to perform the comparison of the reflected signal with the feedback signal based on the mixed signal.

In Example 7, the subject matter of Examples 1-6 includes, wherein the signal processing circuit is configured to determine an atmospheric condition characteristic associated with the location of the wireless device based on the atmospheric attenuation level; and generate the notification to include the atmospheric condition characteristic.

In Example 8, the subject matter of Example 7 includes, wherein to determine the atmospheric condition characteristic, the signal processing circuit is configured to perform post-processing using a look-up table (LUT) and the atmospheric attenuation level.

In Example 9, the subject matter of Examples 7-8 includes, wherein the atmospheric condition characteristic includes at least one of oxygen level; carbon level; humidity level; and air index level, the air index level indicative of air pollution at the location of the wireless device.

Example 10 is a method for determining atmospheric conditions in a vicinity of a wireless device, the method comprising: generating a reference signal; modifying the reference signal to obtain an adjusted reference signal; transmitting the adjusted reference signal via one or more antennas of the wireless device; detecting a reflected signal received by the one or more antennas, the reflected signal corresponding to the adjusted reference signal; performing a comparison of the reflected signal with a feedback signal, the feedback signal generated based on the reference signal; determining an atmospheric attenuation level for a location of the wireless device based on the comparison; and generating a notification based on the atmospheric attenuation level.

In Example 11, the subject matter of Example 10 includes, reducing the power level of the reference signal using a directional coupler, to generate the adjusted reference signal and the feedback signal.

In Example 12, the subject matter of Examples 10-11 includes, outputting the adjusted reference signal to the one or more antennas via a first communication path of a duplexer; and receiving the reflected signal from the one or more antennas via a second communication path of the duplexer.

In Example 13, the subject matter of Example 12 includes, generating a mixed signal using the reflected signal and the feedback signal.

In Example 14, the subject matter of Example 13 includes, performing the comparison of the reflected signal with the feedback signal based on the mixed signal.

In Example 15, the subject matter of Examples 10-14 includes, determining an atmospheric condition characteristic associated with the location of the wireless device based on a look-up table (LUT) and the atmospheric attenuation level; and generating the notification to include the atmospheric condition characteristic.

Example 16 is an apparatus for a wireless device, the apparatus comprising: wireless front-end circuitry configured to generate a reference signal; a directional coupler configured to reduce a power level of the reference signal to generate an adjusted reference signal and a feedback signal; and a signal processing circuit configured to cause transmission of the adjusted reference signal via one or more antennas; detect a reflected signal received by the one or more antennas, the reflected signal corresponding to the adjusted reference signal; perform a comparison of the reflected signal with the feedback signal; determine an atmospheric attenuation level for a location of the wireless device based on the comparison; and generate a notification based on the atmospheric attenuation level.

In Example 17, the subject matter of Example 16 includes, a duplexer, the duplexer configured to output the adjusted reference signal to the one or more antennas via a first communication path; and receive the reflected signal from the one or more antennas via a second communication path.

In Example 18, the subject matter of Examples 16-17 includes, wherein the signal processing circuitry comprises: a quadrature mixer configured to generate a mixed signal using the reflected signal and the feedback signal.

In Example 19, the subject matter of Example 18 includes, wherein the signal processing circuit is configured to perform the comparison of the reflected signal with the feedback signal based on the mixed signal.

In Example 20, the subject matter of Examples 16-19 includes, wherein the signal processing circuit is configured to determine an atmospheric condition characteristic associated with the location of the wireless device based on the atmospheric attenuation level; and generate the notification to include the atmospheric condition characteristic.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

What is claimed is:

1. An apparatus for a wireless device, the apparatus comprising:
a signal generation circuit configured to:
generate a reference signal; and
modify the reference signal to obtain an adjusted reference signal; and
a signal processing circuit configured to:
cause transmission of the adjusted reference signal via one or more antennas;
detect a reflected signal received by the one or more antennas, the reflected signal corresponding to the adjusted reference signal;
perform a comparison of the reflected signal with a feedback signal, the feedback signal generated based on the reference signal;
determine an atmospheric attenuation level for a location of the wireless device based on the comparison; and
generate a notification based on the atmospheric attenuation level.

2. The apparatus of claim 1, wherein the signal generation circuit comprises a directional coupler, the directional coupler configured to:
reduce a power level of the reference signal to generate the adjusted reference signal and the feedback signal.

3. The apparatus of claim 2, wherein the directional coupler is a 3 dB directional coupler, and wherein signal power of the adjusted reference signal is equal to signal power of the feedback signal.

4. The apparatus of claim 2, further comprising a duplexer, the duplexer configured to:
output the adjusted reference signal to the one or more antennas via a first communication path; and
receive the reflected signal from the one or more antennas via a second communication path.

5. The apparatus of claim 4, further comprising:
a quadrature mixer configured to generate a mixed signal using the reflected signal and the feedback signal.

6. The apparatus of claim 5, wherein the signal processing circuit is configured to:
perform the comparison of the reflected signal with the feedback signal based on the mixed signal.

7. The apparatus of claim 1, wherein the signal processing circuit is configured to:
determine an atmospheric condition characteristic associated with the location of the wireless device based on the atmospheric attenuation level; and
generate the notification to include the atmospheric condition characteristic.

8. The apparatus of claim 7, wherein to determine the atmospheric condition characteristic, the signal processing circuit is configured to:
perform post-processing using a look-up table (LUT) and the atmospheric attenuation level.

9. The apparatus of claim 7, wherein the atmospheric condition characteristic includes at least one of:
oxygen level;
carbon level;
humidity level; and
air index level, the air index level indicative of air pollution at the location of the wireless device.

10. A method for determining atmospheric conditions in a vicinity of a wireless device, the method comprising:
generating a reference signal;
modifying the reference signal to obtain an adjusted reference signal and a feedback signal;
transmitting the adjusted reference signal via one or more antennas of the wireless device;
detecting a reflected signal received by the one or more antennas, the reflected signal corresponding to the adjusted reference signal;
performing a comparison of the reflected signal with the feedback signal;
determining an atmospheric attenuation level for a location of the wireless device based on the comparison; and
generating a notification based on the atmospheric attenuation level.

11. The method of claim 10, further comprising:
reducing a power level of the reference signal using a directional coupler, to generate the adjusted reference signal and the feedback signal.

12. The method of claim 10, further comprising:
outputting the adjusted reference signal to the one or more antennas via a first communication path of a duplexer; and
receiving the reflected signal from the one or more antennas via a second communication path of the duplexer.

13. The method of claim 12, further comprising:
generating a mixed signal using the reflected signal and the feedback signal.

14. The method of claim 13, further comprising:
performing the comparison of the reflected signal with the feedback signal based on the mixed signal.

15. The method of claim 10, further comprising:
determining an atmospheric condition characteristic associated with the location of the wireless device based on a look-up table (LUT) and the atmospheric attenuation level; and
generating the notification to include the atmospheric condition characteristic.

16. An apparatus for a wireless device, the apparatus comprising:
wireless front-end circuitry configured to generate a reference signal;
a directional coupler configured to reduce a power level of the reference signal to generate an adjusted reference signal and a feedback signal; and
a signal processing circuit configured to:
cause transmission of the adjusted reference signal via one or more antennas;
detect a reflected signal received by the one or more antennas, the reflected signal corresponding to the adjusted reference signal;
perform a comparison of the reflected signal with the feedback signal;
determine an atmospheric attenuation level for a location of the wireless device based on the comparison; and
generate a notification based on the atmospheric attenuation level.

17. The apparatus of claim 16, further comprising a duplexer, the duplexer configured to:
output the adjusted reference signal to the one or more antennas via a first communication path; and
receive the reflected signal from the one or more antennas via a second communication path.

18. The apparatus of claim 16, wherein the signal processing circuitry comprises:
a quadrature mixer configured to generate a mixed signal using the reflected signal and the feedback signal.

19. The apparatus of claim 18, wherein the signal processing circuit is configured to:
perform the comparison of the reflected signal with the feedback signal based on the mixed signal.

20. The apparatus of claim 16, wherein the signal processing circuit is configured to:
determine an atmospheric condition characteristic associated with the location of the wireless device based on the atmospheric attenuation level; and
generate the notification to include the atmospheric condition characteristic.
